(19) United States
(12) Patent Application Publication
(10) Pub. No.: US 2016/0377913 A1
(43) Pub. Date: Dec. 29, 2016

(54) LIQUID CRYSTAL DISPLAY PANEL

(71) Applicant: Au Optronics Corporation, Hsinchu (TW)

(72) Inventors: Pi-Chun Yeh, Hsinchu County (TW); Ching-Sheng Cheng, Kaohsiung City (TW)

(21) Appl. No.: 14/979,504

(22) Filed: Dec. 27, 2015

(30) Foreign Application Priority Data
Jun. 29, 2015 (TW) 104120976

(51) Int. Cl. G02F 1/1335; G02F 1/1343; G02F 1/1362; G02F 1/1368

(52) U.S. Cl. CPC G02F 1/133512; G02F 1/1368; G02F 1/134309; G02F 1/136286; G02F 1/133514; G02F 2001/133357

(57) ABSTRACT

An LCD panel includes first and second substrates, signal lines, pixel structures, first, second, and third color filter pattern layers, a light-shielding pattern layer, and a liquid crystal medium. The second substrate has first and second light-shielding regions and first, second and third light-transmissive regions. The first and second light-shielding regions define the first, second and third light-transmissive regions. The first color filter pattern layer is correspondingly located in the first light-transmissive regions and the first light-shielding regions. The second color filter pattern layer is correspondingly located in the second light-transmissive regions and the first light-shielding regions. The first and second color filter pattern layers are stacked together in the first light-shielding regions. The third color filter pattern layer is correspondingly located in the third light-transmissive regions. The light-shielding patterned layer is correspondingly located in the second light-shielding regions and on the first, second, and third color filter pattern layers.

### CROSS-REFERENCE TO RELATED APPLICATION

This application claims the priority benefit of Taiwan application serial no. 104120976, filed on Jun. 29, 2015. The entirety of the above-mentioned patent application is hereby incorporated by reference herein and made a part of this specification.

### FIELD OF THE INVENTION

The invention relates to a display panel and in particular to a liquid crystal display (LCD) panel.

### DESCRIPTION OF RELATED ART

As the development of liquid crystal display (LCD) panels advances, high resolution has become one of the basic requirements. In the existing LCD panels, the high-resolution requirement is often satisfied by reducing the dimension of pixels. However, the black matrix layers of the existing LCD panels affected by manufacturing processes, materials, or the like are likely to encounter the issue of corner rounding (as shown in FIG. 1), and thus the aperture ratio of the pixels is lowered down. In order to comply with the high-resolution requirement of the LCD panel, how to prevent the decrease in the aperture ratio is one of the issues to be resolved.

### SUMMARY OF THE INVENTION

The invention is directed to a liquid crystal display (LCD) panel whose traces can be effectively covered to prevent light leakage and/or light of color mixture, and having the high aperture ratio.

In an embodiment of the invention, an LCD panel includes a first substrate, a plurality of first signal lines, a plurality of second signal lines, a plurality of pixel structures, a second substrate, a first color filter pattern layer, a second color filter pattern layer, a third color filter pattern layer, a light-shielding pattern layer, and a liquid crystal medium. The first signal lines and the second signal lines are disposed on the first substrate. The pixel structures are correspondingly electrically connected to the first signal lines and the second signal lines, and each of the pixel structures includes an active device and a first electrode layer. The active device is electrically connected to one of the first signal lines and one of the second signal lines. The first electrode layer is electrically connected to the active device. The second substrate is located opposite to the first substrate, and the second substrate has a plurality of first light-shielding regions, a plurality of second light-shielding regions, a plurality of first light-transmissive regions, a plurality of second light-transmissive regions, and a plurality of third light-transmissive regions. The first light-shielding regions and the second light-shielding regions define the first, second, and third light-transmissive regions. The first color filter pattern layer is correspondingly disposed in the first light-transmissive regions and the first light-shielding regions. The second color filter pattern layer is correspondingly disposed in the second light-transmissive regions and the first light-shielding regions, and the first color filter pattern layer and the second color filter pattern layer are stacked together in the first light-shielding regions. The second color filter pattern layer is substantially completely overlapped with the first signal lines in the first light-shielding regions but not completely overlapped with the second signal lines. The third color filter pattern layer is correspondingly disposed in the third light-transmissive regions. The light-shielding pattern layer is correspondingly disposed in the second light-shielding regions and located on the first, second, and third color filter pattern layers. Here, the light-shielding pattern layer is substantially completely overlapped with the second signal lines in the second light-shielding regions but not completely overlapped with the first signal lines. The liquid crystal medium is configured between the first substrate and the second substrate.

In an embodiment of the invention, another LCD panel includes a first substrate, a plurality of first signal lines, a plurality of second signal lines, a plurality of pixel structures, a liquid crystal medium, a second substrate, a first color filter pattern layer, a second color filter pattern layer, a third color filter pattern layer, and a light-shielding pattern layer. The first signal lines and the second signal lines are disposed on the first substrate. The pixel structures are correspondingly electrically connected to the first signal lines and the second signal lines. The second substrate is located opposite to the first substrate, and the liquid crystal medium is configured between the first substrate and the second substrate. The first color filter pattern layer, the second color filter pattern layer, the third color filter pattern layer, and the light-shielding pattern layer are all disposed between the second substrate and the liquid crystal medium. At least two of the first, second, and third color filter pattern layers are stacked together merely above the first signal lines, and the first, second, and third color filter pattern layers are located between the light-shielding pattern layer and the second substrate.

As discussed above, in the LCD panel provided herein, the first color filter pattern layer and the second color filter pattern layer are stacked together in the first light-shielding regions, and the light-shielding pattern layer on the first, second, and third color filter pattern layers is correspondingly disposed in the second light-shielding regions. Thereby, both light mixture and corner rounding can be prevented, and the aperture ratio can be raised.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is an optical microscopic photograph of a liquid crystal display (LCD) panel with rounding corners.

FIG. 2 is a schematic cross-sectional view illustrating an LCD panel according to an embodiment of the invention.

FIG. 3 is a schematic top view illustrating a portion of the pixel array substrate depicted in FIG. 2.

FIG. 4 is a schematic top view illustrating a portion of the color filter substrate depicted in FIG. 2.

FIG. 5 is a schematic cross-sectional view taken along a sectional line A-A′ depicted in FIG. 4.

FIG. 6 is a schematic cross-sectional view taken along a sectional line B-B′ depicted in FIG. 4.

FIG. 7 is a schematic cross-sectional view taken along a sectional line C-C′ depicted in FIG. 4.

FIG. 8a and FIG. 8b are schematic three-dimensional views illustrating two completely overlapped objects.

FIG. 9 and FIG. 10 are schematic cross-sectional views illustrating a color filter substrate of an LCD panel according to another embodiment of the invention.

FIG. 11 is a schematic cross-sectional view illustrating an LCD panel according to another embodiment of the invention.

FIG. 12 is a schematic top view illustrating a portion of the color filter substrate depicted in FIG. 11.

FIG. 13 is a schematic cross-sectional view taken along a sectional line A-A′ depicted in FIG. 12.

FIG. 14 is a schematic cross-sectional view taken along a sectional line B-B′ depicted in FIG. 12.

FIG. 15 is a schematic cross-sectional view taken along a sectional line C-C′ depicted in FIG. 12.

FIG. 16 is a schematic cross-sectional view illustrating a color filter substrate of an LCD panel according to another embodiment of the invention.

FIG. 17 and FIG. 18 are schematic cross-sectional views illustrating a color filter substrate of an LCD panel according to another embodiment of the invention.

FIG. 19 is a schematic cross-sectional view illustrating a color filter substrate of an LCD panel according to another embodiment of the invention.

FIG. 20 is a schematic cross-sectional view illustrating a color filter substrate of an LCD panel according to another embodiment of the invention.

FIG. 21 is a schematic cross-sectional view illustrating a color filter substrate of an LCD panel according to another embodiment of the invention.

FIG. 22 is a schematic cross-sectional view illustrating a color filter substrate of an LCD panel according to another embodiment of the invention.

### DETAILED DESCRIPTION OF DISCLOSED EMBODIMENTS

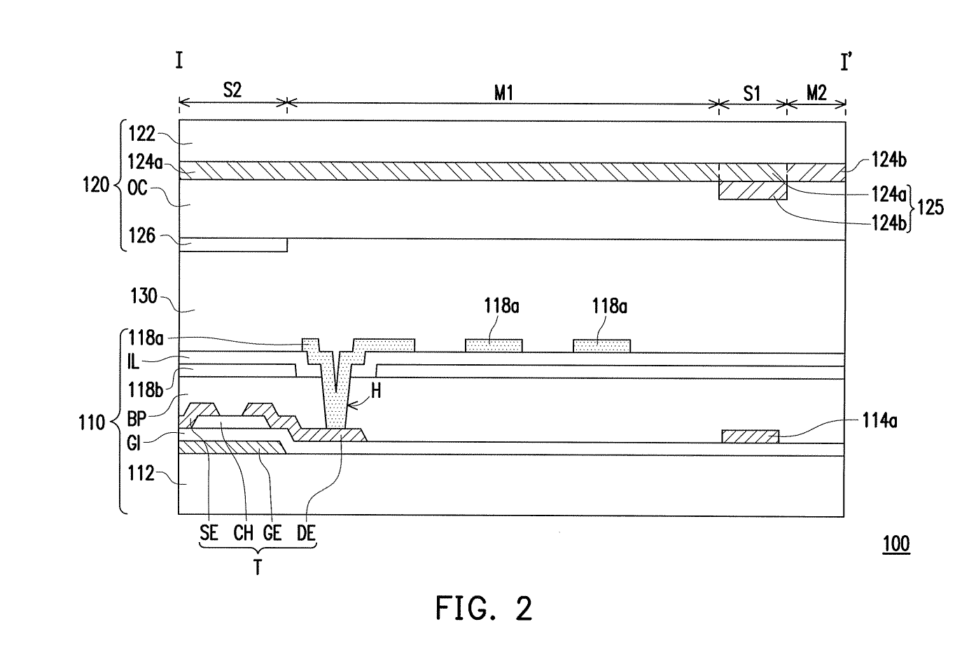

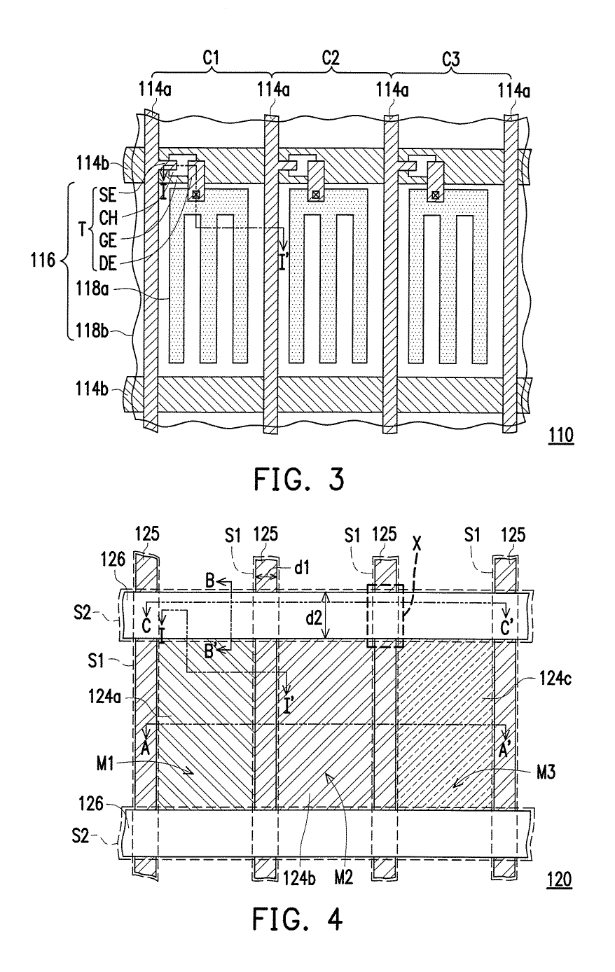

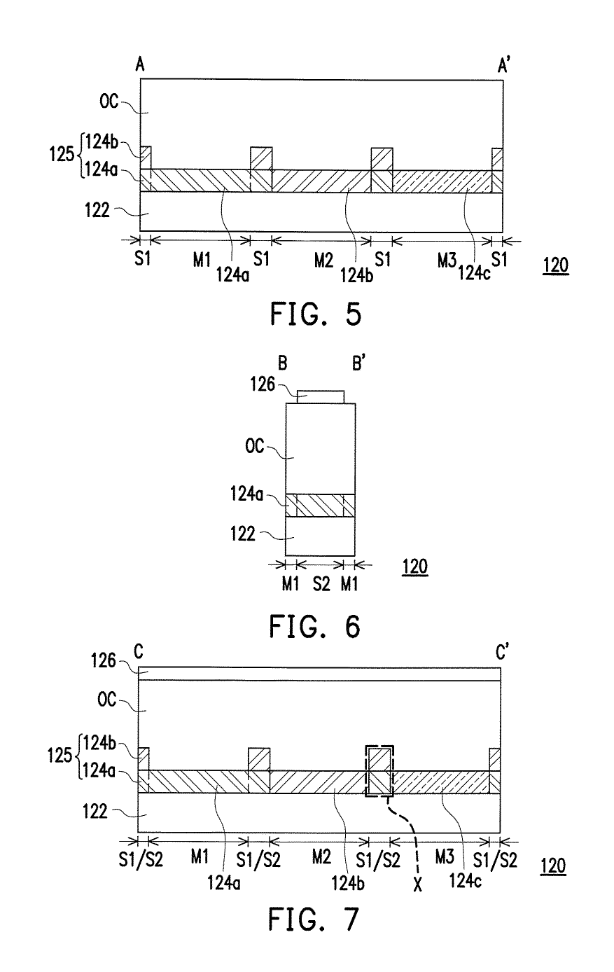

FIG. 2 is a schematic cross-sectional view illustrating an LCD panel according to an embodiment of the invention. FIG. 3 is a schematic top view illustrating a portion of the pixel array substrate depicted in FIG. 2. FIG. 4 is a schematic top view illustrating a portion of the color filter substrate depicted in FIG. 2. FIG. 5 is a schematic cross-sectional view taken along a sectional line A-A′ depicted in FIG. 4. FIG. 6 is a schematic cross-sectional view taken along a sectional line B-B′ depicted in FIG. 4. FIG. 7 is a schematic cross-sectional view taken along a sectional line C-C′ depicted in FIG. 4. Besides, the cross-sectional location depicted in FIG. 2 corresponds to the location of the sectional line I-I′ depicted in FIG. 3 and FIG. 4. An embodiment of the invention is provided hereinafter in detail with reference to FIG. 2, FIG. 3, FIG. 4, FIG. 5, FIG. 6, and FIG. 7.

With reference to FIG. 2, an LCD panel 100 includes a pixel array substrate 110, a color filter substrate 120, and a liquid crystal medium 130. The pixel array substrate 110 and the color filter substrate 120 are opposite to each other. In the following paragraphs, the pixel array substrate 110 and the color filter substrate 120 will be further elaborated. The liquid crystal medium 130 is located between the pixel array substrate 110 and the color filter substrate 120. In this embodiment, the liquid crystal medium 130 refers to liquid crystal molecules, for instance.

With reference to FIG. 2 and FIG. 3, the pixel array substrate 110 includes a first substrate 112, a plurality of first signal lines (here, the first signal lines are, for example, data lines 114a), a plurality of second signal lines (here, the second signal lines are, for example, scan lines 114b), and a plurality of pixel structures 116. The first substrate 112 may be made of glass, quartz, organic polymer, metal, etc.

The data lines 114a and the scan lines 114b are disposed on the first substrate 112. The extension direction of the data lines 114a and the extension direction of the scan lines 114b are not the same; preferably, the extension direction of the data lines 114a and the extension direction of the scan lines 114b are perpendicular. In addition, the data lines 114a and the scan lines 114b are formed from different film layers, and an insulation layer (not shown) is sandwiched therebetween. The data lines 114a and the scan lines 114b respectively serve to transmit data signals and driving signals for driving the pixel structures 116. In consideration of electrical conductivity, the data lines 114a and the scan lines 114b are normally made of metallic materials. However, the invention is not limited thereto. According to another embodiment, the data lines 114a and the scan lines 114b may be made of other conductive materials (such as an alloy, a metal nitride material, a metal oxide material, a metal oxynitride material, or other suitable conductive materials) or a stacked layer having the metal material and the aforesaid conductive materials.

The pixel structures 116 are arranged in an array to constitute a plurality of pixel columns C1-Cn; in FIG. 3, three of the pixel columns C1-C3 are depicted. Since FIG. 3 merely shows a portion of the pixel array substrate 110, three of the pixel columns C1-C3 and three corresponding pixel structures 116 are schematically illustrated.

Each of the pixel structures 116 is electrically connected to the corresponding data line 114a and the corresponding scan line 114b. Particularly, each of the pixel structures 116 includes an active device T, a first electrode layer 118a, and a second electrode layer 118b. Each of the active devices T is electrically connected to the corresponding data line 114a and the corresponding scan line 114b. In the present embodiment, the active device T is a thin film transistor (TFT) that includes a gate GE, a channel layer CH, a drain DE, and a source SE.

The gate GE and the scan line 114b are electrically connected to each other. In the present embodiment, a portion of the scan line 114b serves as the gate GE. The source SE and the data line 114a are electrically connected to each other.

The channel layer CH is located above the gate GE. The source SE and the drain DE are located above the channel layer CH. Particularly, in the present embodiment, the active device T is a bottom-gate TFT, for instance; however, the invention is not limited thereto. In another embodiment of the invention, the active device T is, for example, a top-gate TFT.

According to the present embodiment, a gate insulation layer GI is further formed above the gate GE of the active device T. A passivation layer BP further covers the active device T. The gate insulation layer GI and the passivation layer BP may be made of an inorganic material, an organic material, or a combination thereof. Here, the inorganic material is silicon oxide, silicon nitride, silicon oxynitride, or a stacked layer having at least two of the above-mentioned materials, for instance. The organic material is, for instance, polymer material, such as polyimide (PI) resin, epoxy resin, or acrylic resin.

The first electrode layer 118a is electrically connected to the drain DE of the active device T. Particularly, in the present embodiment, the first electrode layer 118a is electrically connected to the drain DE through a contact window H. The first electrode layer 118a is a transparent conductive layer, for instance, and a material of the first electrode layer 118a includes a metal oxide conductive material, such as indium tin oxide (ITO), indium zinc oxide (IZO), aluminum zinc oxide (AZO), aluminum tin oxide (ATO), indium germanium zinc oxide (IGZO), other suitable oxides, or a stacked layer having at least two of the aforesaid materials. In the present embodiment, the first electrode layer 118a includes a plurality of bar-shaped electrode patterns.

In the present embodiment, an interlayer insulation layer IL is further arranged between the second electrode layer 118b and the first electrode layer 118a, so as to electrically insulate the second electrode layer 118b from the first electrode layer 118a. The interlayer insulation layer IL may be made of an inorganic material, an organic material, or a combination thereof. Here, the inorganic material is silicon oxide, silicon nitride, silicon oxynitride, or a stacked layer having at least two of the above-mentioned materials, for instance. The organic material is, for instance, polymer material, such as PI resin, epoxy resin, or acrylic resin.

A potential difference exists between the first electrode layer 118a and the second electrode layer 118b. Particularly, in the present embodiment, the liquid crystal medium 130 is substantially driven by the potential difference between the first electrode layer 118a and the second electrode layer 118b. The second electrode layer 118b is a transparent conductive layer, for instance, and a material of the second electrode layer 118b includes a metal oxide conductive material, such as ITO, IZO, AZO, ATO, IGZO, other suitable oxides, or a stacked layer having at least two of the aforesaid materials. In the present embodiment, the second electrode layer 118b has no bar-shaped patterns.

Specifically, in the present embodiment, the LCD panel 100 is a fringe field switching (FFS) LCD panel.

As shown in FIG. 2, the first electrode layer 118a of each pixel structure 116 includes a plurality of bar-shaped electrode patterns, the second electrode layer 118b is an intact electrode layer, the second electrode layer 118b is disposed on the passivation layer BP, and the interlayer insulation layer IL is arranged between the second electrode layer 118b and the first electrode layer 118a. However, the invention is not limited thereto. In another embodiment of the invention, the pixel structures 116 may have any configuration of pixel structure in the known FFS LCD panel. For instance, the first electrode layer 118a may be the intact electrode layer, and the second electrode layer 118b may include the bar-shaped patterns and may be located above the first electrode layer 118a.

Besides, the configuration of the first electrode layer 118a is not limited to that illustrated in FIG. 3. That is, the first electrode layer 118a may be any configuration of electrode layer in the known FFS LCD panel. For instance, the bar-shaped patterns of the first electrode layer 118a have a straight-line shape, as shown in FIG. 3; however, in other embodiments of the invention, the bar-shaped patterns of the first electrode layer 118a may also have a “<<” shape, in a wave-like shape, or the like.

Besides, although the first electrode layer 118a includes three bar-shaped electrode patterns, the invention is not limited thereto. In other embodiments of the invention, the number of bar-shaped electrode patterns can be adjusted by people having ordinary skill in the pertinent art according to actual needs.

Although the LCD panel 100 provided in the present embodiment is the FFS LCD panel, the invention is not limited thereto. In another embodiment of the invention, the LCD panel 100 may also be an in-plane switching (IPS) LCD panel, or in another embodiment of the invention, the LCD panel 100 may not be equipped with the second electrode layer 118b and may have the first electrode layer 118a which is an intact electrode layer.

With reference to FIG. 2 and FIG. 4 to FIG. 7, the color filter substrate 120 includes a second substrate 122, the first color filter pattern layer 124a, the second color filter pattern layer 124b, the third color filter pattern layer 124c, and the light-shielding pattern layer 126.

The second substrate 122 has a plurality of first light-shielding regions S1, a plurality of second light-shielding regions S2, a plurality of first light-transmissive regions M1, a plurality of second light-transmissive regions M2, and a plurality of third light-transmissive regions M3. The first light-shielding regions S1 and the second light-shielding regions S2 define the first, second, and third light-transmissive regions M1, M2, and M3. It should be mentioned that FIG. 4 merely illustrates a portion of the color filter substrate 120; therefore, four of the first light-shielding regions S1, two of the second light-shielding regions S2, one of the first light-transmissive regions M1, one of the second light-transmissive regions M2, and one of the third light-transmissive regions M3 are schematically shown in FIG. 4. The second substrate 122 may be made of glass, quartz, organic polymer, metal, etc.

The first and second light-shielding regions S1 and S2 correspond to regions where devices that do not serve to display images and should be covered are located; the first, second, and third light-transmissive regions M1, M2, and M3 correspond to regions where devices that serve to display images are located. To be specific, with reference to FIG. 3 and FIG. 4, in the present embodiment, the first light-shielding regions S1 and the data lines 114a are spatially overlapped, the second light-shielding regions S2 and the scan lines 114b are spatially overlapped, and the first, second, and third light-transmissive regions M1, M2, and M3 are each spatially overlapped with corresponding one of the first electrode layers 118a. In another aspect, as provided above, the extension directions of the data lines 114a and the scan lines 114b are not the same, and thus the overlapping portions of the first and second light-shielding regions S1 and S2 are intersecting regions X. Besides, in the present embodiment, a width d1 of the first light-shielding regions S1 corresponds to the data lines 114a, a width d2 of the second light-shielding regions S2 corresponds to the scan lines 114b, and thereby the width d1 of the first light-shielding regions S1 is smaller than the width of the second light-shielding regions S2. Specifically, in the present embodiment, the width d1 is approximately 2 μm to 8 μm, and the width d2 is approximately 10 μm to 40 μm.

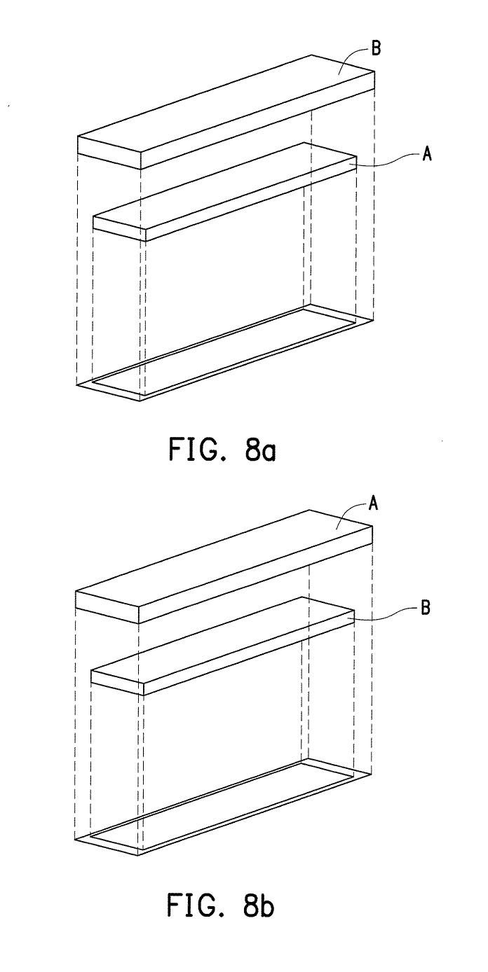

The first color filter pattern layer 124a is correspondingly disposed in the first light-transmissive regions M1 and the first light-shielding regions S1. To be specific, as provided above, the first light-shielding regions S1 and the data lines 114a are spatially overlapped, and the first light-transmissive regions M1 and the corresponding first electrode layers 118a are spatially overlapped; thereby, the portion of the first color filter pattern layer 124a corresponding to each first light-shielding region S1 is overlapped with corresponding one of the data lines 114a, and the portion of the first color filter pattern layer 124a corresponding to each first light-transmissive region M1 is overlapped with the corresponding first electrode layer 118a. In another aspect, the overlapping portions of the first and second light-shielding regions S1 and S2 are the intersecting regions X, and therefore the portions of the first color filter pattern layer 124a corresponding to the first light-shielding regions S1 are substantially completely overlapped with the data lines 114a but not completely overlapped with the scan lines 114b. In this disclosure, the definition of “completely overlapped” is provided below. If an object A and an object B are completely overlapped, it means the orthogonal projection of the object A is completely located within the orthogonal projection of the object B or the orthogonal projection of the object A is completely overlapped with the orthogonal projection of the object B (as shown in FIG. 8a), or the orthogonal projection of the object B is completely located within the orthogonal projection of the object A or the orthogonal projection of the object B is completely overlapped with the orthogonal projection of the object A (as shown in FIG. 8b).

The second color filter pattern layer 124b is correspondingly disposed in the second light-transmissive regions M2 and the first light-shielding regions S1. Similarly, as provided above, the portion of the second color filter pattern layer 124b corresponding to each first light-shielding region S1 is overlapped with the corresponding data line 114a, and the portion of the second color filter pattern layer 124b corresponding to each second light-transmissive regions M2 is overlapped with the corresponding first electrode layer 118a. The portions of the second color filter pattern layer 124b corresponding to the first light-shielding regions S1 are substantially completely overlapped with the data lines 114a but not completely overlapped with the scan lines 114b.

With reference to FIG. 4, FIG. 5, and FIG. 7, in the first light-shielding regions S1, the second color filter pattern layer 124b is stacked onto the first color filter pattern layer 124a, so as to form a plurality of stacked structures 125. From another perspective, the second color filter pattern layer 124b is spatially overlapped with the first color filter pattern layer 124a merely above the data lines 114a. That is, the stacked structures 125 constituted by the second color filter pattern layer 124b and the first color filter pattern layer 124a are spatially completely overlapped with the data lines 114a. It should be mentioned that the optical density of the stacked structures 125 constituted by the second color filter pattern layer 124b and the first color filter pattern layer 124a is approximately 2-5; hence, the stacked structures 125 are capable of achieving effective light-shielding effects. As such, the stacked structures 125 located in the first light-shielding regions S1 can effectively cover the data lines 114a that are not supposed to be observed by users.

The third color filter pattern layer 124c is correspondingly disposed in the third light-transmissive regions M3. Similarly, as provided above, the portion of the third color filter pattern layer 124c corresponding to each third light-transmissive region M3 is overlapped with the corresponding first electrode layer 118a.

Colors of the first, second and third color filter pattern layers 124a, 124b, and 124c are different and are selected from red, green, and blue, respectively. In particular, the colors of the first, second, and third color filter pattern layers 124a, 124b, and 124c in the present embodiment are red, green, and blue, respectively. That is, when light beams pass through the first, second, and third light-transmissive regions M1, M2, and M3, the display frame of the LCD panel 100 corresponding to the first, second, and third light-transmissive regions M1, M2, and M3 appears to be red, green, and blue, respectively.

As shown in FIG. 4 and FIG. 5, in the present embodiment, the stacked structures 125 in the first light-shielding regions S1 are all constituted by stacking the first and second color filter pattern layers 124a and 124b; however, the invention is not limited thereto. In other embodiments of the invention, the way to stack the filter patterns in the stacked structures 125 may be changed in response to variations in actual manufacturing conditions. For instance, according to an embodiment of the invention, the stacked structures 125 may sequentially include a stacked structure constituted by the first and second color filter pattern layers 124a and 124b, a stacked structure constituted by the first and second color filter pattern layers 124a and 124b, a stacked structure constituted by the second and third color filter pattern layers 124b and 124c, and a stacked structure constituted by the first and third color filter pattern layers 124a and 124c.

With reference to FIG. 3, FIG. 4, FIG. 6, and FIG. 7, in the present embodiment, the first, second, and third color filter pattern layers 124a, 124b, and 124c are sequentially arranged on the first, second, and third pixel columns C1, C2, and C3, respectively. That is, in the present embodiment, the first light-transmissive regions M1 correspond to the first pixel column C1, the second light-transmissive regions M2 correspond to the second pixel column C2, the third light-transmissive regions M3 correspond to the third pixel column C3, the first color filter pattern layer 124a is correspondingly arranged in the second light-shielding regions S2 among adjacent first light-transmissive regions M1, the second color filter pattern layer 124b is correspondingly arranged in the second light-shielding regions S2 among adjacent second light-transmissive regions M2, and the third color filter pattern layer 124c is correspondingly arranged in the second light-shielding regions S2 among adjacent third light-transmissive regions M3, as shown in FIG. 6 and FIG. 7. It should be mentioned that the LCD panel 100 provided herein need not be formed by using complicated photomasks due to the arrangement of the first, second, and third color filter pattern layers 124a, 124b, and 124c sequentially corresponding to the first, second, and third pixel column C1, C2, and C3; thereby, the LCD panel 100 can be characterized by the simple manufacturing process and the low manufacturing costs.

The light-shielding pattern layer 126 is correspondingly located in the second light-shielding regions S2. Specifically, as provided above, the second light-shielding regions S2 are spatially overlapped with the scan lines 114b, such that the portion of the light-shielding pattern layer 126 corresponding to each second light-shielding region S2 is overlapped with the corresponding scan line 114b. In another aspect, the overlapping portions of the first and second light-shielding regions S1 and S2 is the intersecting regions X, and therefore the portions of the light-shielding pattern layer 126 corresponding to the second light-shielding regions S2 are substantially completely overlapped with the scan lines 114b but not completely overlapped with the data lines 114a.

Besides, the light-shielding pattern layer 126 is located on the first, second, and third color filter pattern layers 124a, 124b, and 124c. That is, the first, second, and third color filter pattern layers 124a, 124b, and 124c are located between the light-shielding pattern layer 126 and the second substrate 122. According to the present embodiment, in order for the light-shielding pattern layer 126 to be formed on a surface with satisfactory degree of flatness, the LCD panel 100 may further include a planarization layer OC located between the light-shielding pattern layer 126 and the first, second, and third color filter pattern layers 124a, 124b, and 124c. The planarization layer OC may be made of an inorganic material, an organic material, or a combination thereof. Here, the inorganic material is silicon oxide, silicon nitride, silicon oxynitride, or a stacked layer having at least two of the above-mentioned materials, for instance. The organic material is, for instance, polymer material, such as PI resin, epoxy resin, or acrylic resin.

Here, a material of the light-shielding pattern layer 126 includes black resin or metal. The optical density of the light-shielding pattern layer 126 is approximately 3-7; hence, the light-shielding pattern layer 126 is capable of achieving effective light-shielding effects. As such, the light-shielding pattern layer 126 located in the second light-shielding regions S2 can effectively cover the scan lines 114b and the active devices T that are not supposed to be observed by users.

In the present embodiment, the stacked structures 125 (constituted by the second and first color filter pattern layers 124b and 124a) and the light-shielding pattern layer 126 which belong to different film layers are respectively arranged in the first and second light-shielding regions S1 and S2; thereby, the stacked structures 125 and the light-shielding pattern layer 126 can replace the conventional black matrix layer and effectively block the data lines 114a, the scan lines 114b, and the active devices T that are not supposed to be observed by the users, and both light mixture and corner rounding in the LCD panel 100 can be prevented, such that the aperture ratio can be raised. As a result, compared with the conventional LCD panel, the LCD panel 100 provided in the present embodiment can have high resolution, and can still effectively block the devices from the users' sight and have satisfactory aperture ratio.

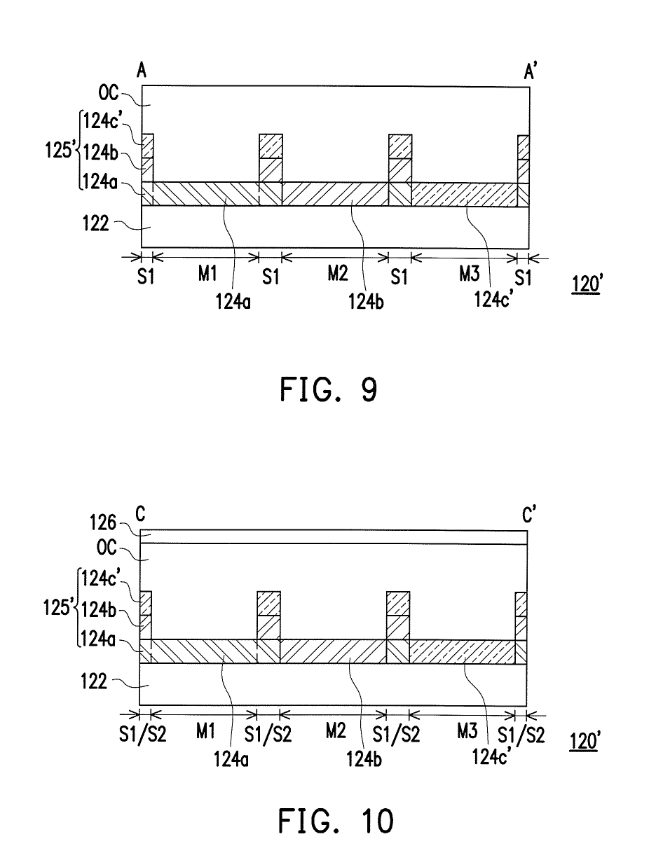

Besides, in the embodiment shown in FIG. 4 to FIG. 7, the stacked structures 125 in the color filter substrate 120 are constituted by two color filter pattern layers, which should however not be construed as a limitation to the invention. In another embodiment of the invention, the stacked structures may be constituted by three color filter pattern layers, such that the stacked structures can achieve better light-shielding effects. Detailed descriptions are provided hereinafter with reference to FIG. 9 and FIG. 10.

FIG. 9 and FIG. 10 are schematic cross-sectional views illustrating a color filter substrate of an LCD panel according to another embodiment of the invention. The top schematic view illustrating the color filter substrate 120′ depicted in FIG. 9 and FIG. 10 can be similar to that provided in FIG. 4, wherein the location of the sectional line A-A′ in FIG. 4 may serve as a reference of the cross-sectional location shown in FIG. 9, and the location of the sectional line C-C′ in FIG. 4 may serve as a reference of the cross-sectional location shown in FIG. 10. The embodiment depicted in FIG. 9 and FIG. 10 is similar to that depicted in FIG. 4 to FIG. 7; therefore, the identical or similar devices in these embodiments are represented by the identical or similar reference numbers and will not be further explained.

As shown in FIG. 5, FIG. 7, FIG. 9, and FIG. 10, the difference between the color filter substrate 120′ and the color filter substrate 120 lies in that the third color filter pattern layer 124c′ in the color filter substrate 120′ is further disposed in the first light-shielding regions S1 and is stacked onto the second and first color filter pattern layers 124b and 124a, so as to form a plurality of stacked structures 125′. In the color filter substrate 120, the third color filter pattern layer 124c is not disposed in the first light-shielding regions S1, and the stacked structures 125 are merely constituted by the second and first color filter pattern layers 124b and 124a.

It should be mentioned that the optical density of the stacked structures 125′ constituted by the third color filter pattern layer 124c′, the second color filter pattern layer 124b, and the first color filter pattern layer 124a is approximately 3-6; hence, the stacked structures 125′ are capable of achieving better light-shielding effects in comparison with the stacked structures 125. As such, compared with the stacked structures 125, the stacked structures 125′ located in the first light-shielding regions S1 can more effectively cover the devices that are not supposed to be observed by users.

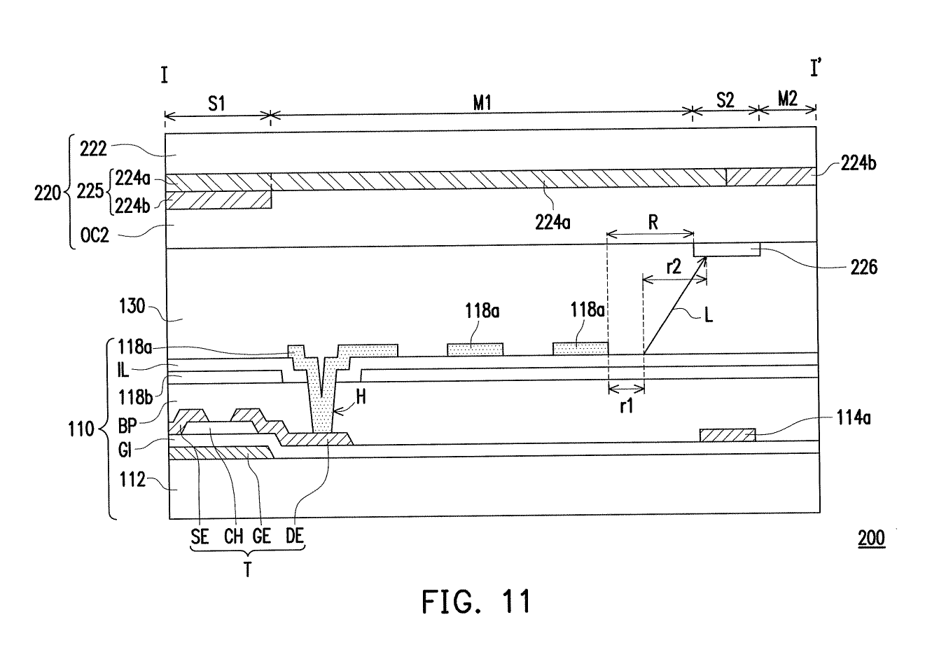

With reference to FIG. 2 to FIG. 7, the first signal lines are data lines 114a, and the second signal lines are scan lines 114b; however, the invention is not limited thereto. In other embodiments of the invention, the first signal lines may also be the scan lines, and the second signal lines can be the data lines. Detailed descriptions are provided hereinafter with reference to FIG. 11 and FIG. 15.

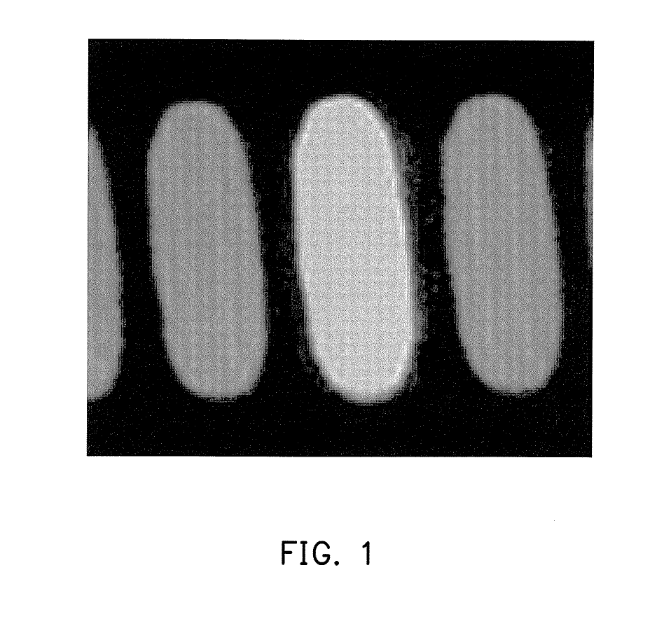

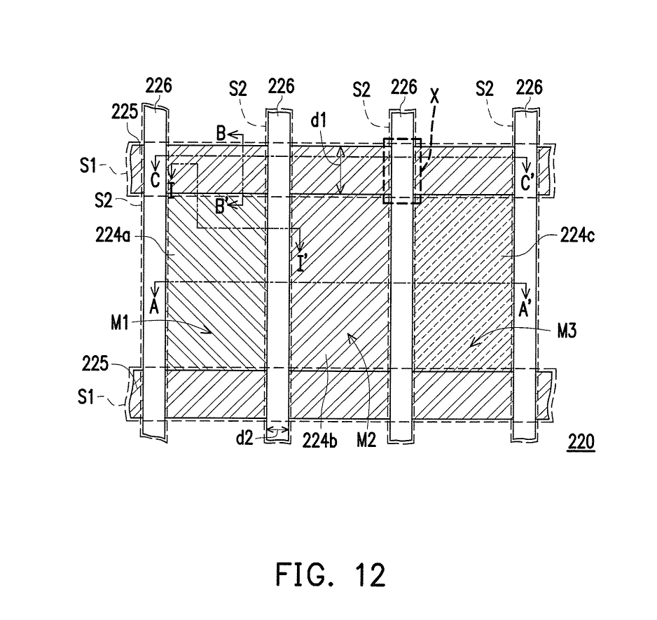

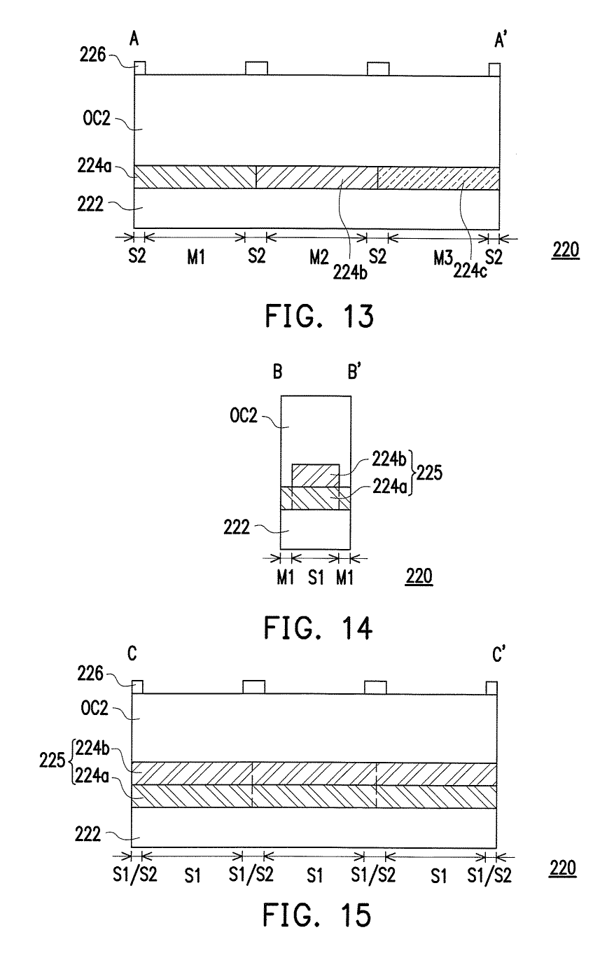

FIG. 11 is a schematic cross-sectional view illustrating an LCD panel according to another embodiment of the invention. FIG. 12 is a schematic top view illustrating a portion of the color filter substrate depicted in FIG. 11. FIG. 13 is a schematic cross-sectional view taken along a sectional line A-A′ depicted in FIG. 11. FIG. 14 is a schematic cross-sectional view taken along a sectional line B-B′ depicted in FIG. 11. FIG. 15 is a schematic cross-sectional view taken along a sectional line C-C′ depicted in FIG. 11. Besides, the cross-sectional location depicted in FIG. 11 corresponds to the location of the sectional line I-I′ depicted in FIG. 12. Note that the LCD panel 200 depicted in FIG. 11 is similar to the LCD panel 100 depicted in FIG. 1, and the difference therebetween lies in that the color filter substrates in the LCD panels 200 and 100 have different detailed structures. Therefore, the identical or similar devices in the LCD panel 200 depicted in FIG. 11 and the LCD panel 100 depicted in FIG. 1 are represented by the identical or similar reference numbers and will not be further explained. The difference between the LCD panels will be elaborated hereinafter.

With reference to FIG. 11 to FIG. 15, the color filter substrate 220 includes a second substrate 222, a first color filter pattern layer 224a, a second color filter pattern layer 224b, a third color filter pattern layer 224c, and a light-shielding pattern layer 226.

The second substrate 222 has a plurality of first light-shielding regions S1, a plurality of second light-shielding regions S2, a plurality of first light-transmissive regions M1, a plurality of second light-transmissive regions M2, and a plurality of third light-transmissive regions M3. The first light-shielding regions S1 and the second light-shielding regions S2 define the first, second, and third light-transmissive regions M1, M2, and M3. It should be mentioned that FIG. 12 merely illustrates a portion of the color filter substrate 220; therefore, two of the first light-shielding regions S1, four of the second light-shielding regions S2, one of the first light-transmissive regions M1, one of the second light-transmissive regions M2, and one of the third light-transmissive regions m3 are schematically shown in FIG. 12. The second substrate 222 may be made of glass, quartz, organic polymer, metal, etc.

The first and second light-shielding regions S1 and S2 correspond to regions where devices that do not serve to display images and should be covered are located; the first, second, and third light-transmissive regions M1, M2, and M3 correspond to regions where devices that serve to display images are located. To be specific, with reference to FIG. 3 and FIG. 12, in the present embodiment, the first light-shielding regions S1 and the scan lines 114b are spatially overlapped, the second light-shielding regions S2 and the data lines 114a are spatially overlapped, and the first, second, and third light-transmissive regions M1, M2, and M3 are each spatially overlapped with corresponding one of the first electrode layers 118a. In another aspect, as provided above, the extension directions of the data lines 114a and the scan lines 114b are not the same, and thus the overlapping portions of the first and second light-shielding regions S1 and S2 are intersecting regions X. Besides, in the present embodiment, a width d1 of the first light-shielding regions S1 corresponds to the scan lines 114b, a width d2 of the second light-shielding regions S2 corresponds to the data lines 114a, and thereby the width d1 of the first light-shielding regions S1 is greater than the width of the second light-shielding regions S2. Specifically, in the present embodiment, the width d1 is approximately 10 μm to 40 μm, and the width d2 is approximately 2 μm to 8 μm.

The first color filter pattern layer 224a is correspondingly disposed in the first light-transmissive regions M1 and the first light-shielding regions S1. To be specific, as provided above, the first light-shielding regions S1 and the scan lines 114b are spatially overlapped, and the first light-transmissive regions M1 and the corresponding first electrode layers 118a are spatially overlapped; thereby, the portion of the first color filter pattern layer 224a corresponding to each first light-shielding region S1 is overlapped with the corresponding scan line 114b, and the portion of the first color filter pattern layer 224a corresponding to each first light-transmissive region M1 is overlapped with the corresponding first electrode layer 118a. In another aspect, the overlapping portions of the first and second light-shielding regions S1 and S2 is the intersecting regions X, and therefore the portions of the first color filter pattern layer 224a corresponding to the first light-shielding regions S1 are substantially completely overlapped with the scan lines 114b but not completely overlapped with the data lines 114a.

The second color filter pattern layer 224b is correspondingly disposed in the second light-transmissive regions M2 and the first light-shielding regions S1. Similarly, as provided above, the portion of the second color filter pattern layer 224b corresponding to each first light-shielding region S1 is overlapped with the corresponding scan line 114b, and the portion of the second color filter pattern layer 224b corresponding to each second light-transmissive region M2 is overlapped with the corresponding first electrode layer 118a. The portions of the second color filter pattern layer 224b corresponding to the first light-shielding regions S1 are substantially completely overlapped with the scan lines 114b but not completely overlapped with the data lines 114a.

Particularly, with reference to FIG. 12, FIG. 14, and FIG. 15, in the first light-shielding regions S1, the second color filter pattern layer 224b is stacked onto the first color filter pattern layer 224a, so as to form a plurality of stacked structures 225. From another perspective, the second color filter pattern layer 224b is spatially overlapped with the first color filter pattern layer 224a merely above the scan lines 114b. That is, the stacked structures 225 constituted by the second color filter pattern layer 224b and the first color filter patterned layer 224a are spatially completely overlapped with the scan lines 114b. It should be mentioned that the optical density of the stacked structures 225 constituted by the second color filter pattern layer 224b and the first color filter pattern layer 224a is approximately 2-5; hence, the stacked structures 225 are capable of achieving effective light-shielding effects. As such, the stacked structures 225 located in the first light-shielding regions S1 can effectively cover the scan lines 114b and the active devices T that are not supposed to be observed by users.

The third color filter pattern layer 224c is correspondingly disposed in the third light-transmissive regions M3. Similarly, as provided above, the portion of the third color filter pattern layer 224c corresponding to each third light-transmissive region M3 is overlapped with the corresponding first electrode layer 118a.

Colors of the first, second, and third color filter pattern layers 224a, 224b, and 224c are different and are selected from red, green, and blue, respectively. In particular, the colors of the first, second, and third color filter pattern layers 224a, 224b, and 224c in the present embodiment are red, green, and blue, respectively. That is, when light beams pass through the first, second, and third light-transmissive regions M1, M2, and M3, the display frame of the LCD panel 200 corresponding to the first, second, and third light-transmissive regions M1, M2, and M3 appears to be red, green, and blue, respectively.

With reference to FIG. 3 and FIG. 12 to FIG. 15, in the present embodiment, the first, second, and third color filter pattern layers 224a, 224b, and 224c are sequentially arranged on the first, second, and third pixel columns C1, C2, and C3, respectively. That is, in the present embodiment, the first light-transmissive regions M1 correspond to the first pixel column C1, the second light-transmissive regions M2 correspond to the second pixel column C2, and the third light-transmissive regions M3 correspond to the third pixel column C3. It should be mentioned that the LCD panel 200 provided herein need not be formed by using complicated photomasks due to the arrangement of the first, second, and third color filter pattern layers 224a, 224b, and 224c sequentially corresponding to the first, second, and third pixel column C1, C2, and C3; thereby, the LCD panel 200 can be characterized by the simple manufacturing process and the low manufacturing costs.

The light-shielding pattern layer 226 is correspondingly located in the second light-shielding regions S2. Specifically, as provided above, the second light-shielding regions S2 are spatially overlapped with the data lines 114a, such that the portion of the light-shielding pattern layer 226 corresponding to each second light-shielding region S2 is overlapped with the corresponding data line 114a. In another aspect, the overlapping portions of the first and second light-shielding regions S1 and S2 are the intersecting regions X, and therefore the portions of the light-shielding pattern layer 226 corresponding to the second light-shielding regions S2 are substantially completely overlapped with the data lines 114a but not completely overlapped with the scan lines 114b.

Besides, the light-shielding pattern layer 226 is located on the first, second, and third color filter pattern layers 224a, 224b, and 224c. That is, the first, second, and third color filter pattern layers 224a, 224b, and 224c are located between the light-shielding pattern layer 226 and the second substrate 222. According to the present embodiment, in order for the light-shielding pattern layer 226 to be formed on a surface with satisfactory degree of flatness, the LCD panel 200 may further include a planarization layer OC2 located between the light-shielding pattern layer 226 and the first, second, and third color filter pattern layers 224a, 224b, and 224c. The planarization layer OC2 may be made of an inorganic material, an organic material, or a combination thereof. Here, the inorganic material is silicon oxide, silicon nitride, silicon oxynitride, or a stacked layer having at least two of the above-mentioned materials, for instance. The organic material is, for instance, polymer material, such as PI resin, epoxy resin, or acrylic resin.

Here, a material of the light-shielding pattern layer 226 includes black resin or metal. The optical density of the light-shielding pattern layer 226 is approximately 3-7; hence, the light-shielding pattern layer 226 is capable of achieving effective light-shielding effects. As such, the light-shielding pattern layer 226 located in the second light-shielding regions S2 can effectively cover the data lines 114a that are not supposed to be observed by users.

It should be mentioned that the stacked structures 225 (constituted by the second and first color filter pattern layers 224b and 224a) and the light-shielding pattern layer 226 which belong to different film layers are respectively arranged in the first and second light-shielding regions S1 and S2; thereby, the stacked structures 225 and the light-shielding pattern layer 226 can replace the conventional black matrix layer and effectively block the data lines 114a, the scan lines 114b, and the active devices T that are not supposed to be observed by the users, and both light mixture and corner rounding in the LCD panel 200 can be prevented, such that the aperture ratio can be raised. As a result, compared with the conventional LCD panel, the LCD panel 200 provided in the present embodiment can have high resolution, and can still effectively block the devices from the users' sight and have satisfactory aperture ratio.

In addition, according to the present embodiment, the light-shielding pattern layer 226 is arranged on the planarization layer OC2, such that the distance form the electrode layer to the light-shielding pattern layer can be reduced; as a result, the issue of chromatic aberration arising from observing the LCD panel 200 at the large view angle can be effectively resolved. Detailed descriptions are provided hereinafter with reference to FIG. 11.

As shown in FIG. 11, compared with the conventional LCD panel having the light-shielding pattern layer sandwiched between the substrate and the color filter pattern layer, the LCD panel 200 provided herein has the light-shielding pattern layer 226 arranged on the planarization layer OC2, and thus the horizontal distance R from the electrode layer to the light-shielding pattern layer is reduced. The horizontal distance R is approximately 4 μm to 9 μm. According to the color mixing rule, people having ordinary skill in the pertinent art should be able to comprehend that the issue of chromatic aberration arising from observing the LCD panel 200 at the large view angle can be effectively resolved, as compared to the conventional LCD panel. Specifically, in the present embodiment, the distance r1 is approximately 2 μm to 6 μm, and the distance r2 is approximately 1 μm to 4 μm, for example.

From another perspective, as shown in FIG. 11, the light beam L at a large angle (i.e., at a large view angle) can be effectively blocked by the light-shielding pattern layer 226, such that the light beam L corresponding to the first light-transmissive regions M1 does not transmit out of the adjacent second light-transmissive regions M2; thereby, the issue of chromatic aberration arising from observing the LCD panel 200 at the large view angle can be better resolved, and the viewing angle range of the LCD panel 200 can be expanded.

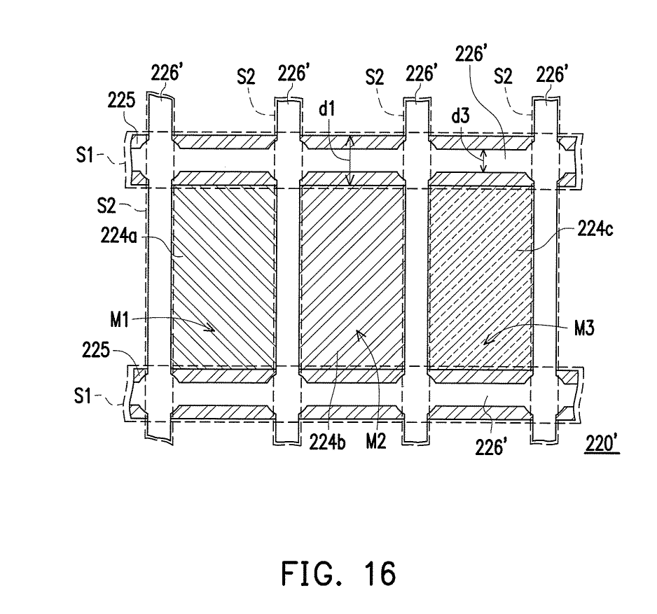

Besides, according to the embodiment shown in FIG. 11 to FIG. 15, the light-shielding pattern layer 226 with the relatively high optical density is merely arranged in the second light-shielding regions S2; however, the invention is not limited thereto. In other embodiments of the invention, the light-shielding pattern layer can also be correspondingly arranged in the first light-shielding regions, so as to enhance the light-shielding effects. Detailed descriptions are provided hereinafter with reference to FIG. 16.

FIG. 16 is a schematic cross-sectional view illustrating a color filter substrate of an LCD panel according to another embodiment of the invention. The embodiment depicted in FIG. 16 is similar to that depicted in FIG. 11 to FIG. 15; therefore, the identical or similar devices in these embodiments are represented by the identical or similar reference numbers and will not be further explained.

With reference to FIG. 16 and FIG. 12, the difference between the color filter substrate 220′ shown in FIG. 16 and the color filter substrate 220 shown in FIG. 12 lies in that the light-shielding pattern layer 226′ in the color filter substrate 220′ shown in FIG. 16 is further correspondingly arranged in the first light-shielding regions S1, and the width d3 of the light-shielding pattern layer 226′ in each of the first light-shielding regions S1 is less than the width d1 of each of the first light-shielding regions S1. That is, the light-shielding pattern layer 226′ includes a shape as a crisscross and is merely arranged in parts of the first light-shielding regions S1. Spatially, the portion of the light-shielding pattern layer 226′ corresponding to each first light-shielding region S1 is overlapped with a portion of the corresponding stacked structure 225.

It should be mentioned that the stacked structures 225 and the light-shielding pattern layer 226′ are correspondingly arranged in the first light-shielding regions S1 according to the embodiments depicted in FIG. 16, so as to further enhance the light-shielding effects in the first light-shielding regions S1 and further effectively prevent the light beam from passing through the first light-shielding regions S1. Particularly, in the present embodiment, the optical density of the overlapping region between the light-shielding pattern layer 226′ and the stacked structures 225 is approximately 4-7. In general, the higher the optical density, the greater the light-shielding effects.

In the embodiment shown in FIG. 16, the corner rounding issue arising from the light-shielding pattern layer 226′ is inevitable; nevertheless, the width d3 of the light-shielding pattern layer 226′ in each of the first light-shielding regions S1 is less than the width d1 of each of the first light-shielding regions S1. Therefore, although the corner rounding issue arises from the light-shielding pattern layer 226′, the coverage of the corner rounding is spatially overlapped with the stacked structures 225. Thereby, compared with the conventional LCD panel which employs the black matrix layer to cover the traces (e.g., first and second signal lines), the LCD panel having the color filter substrate 220′ still can be characterized by favorable aperture ratio.

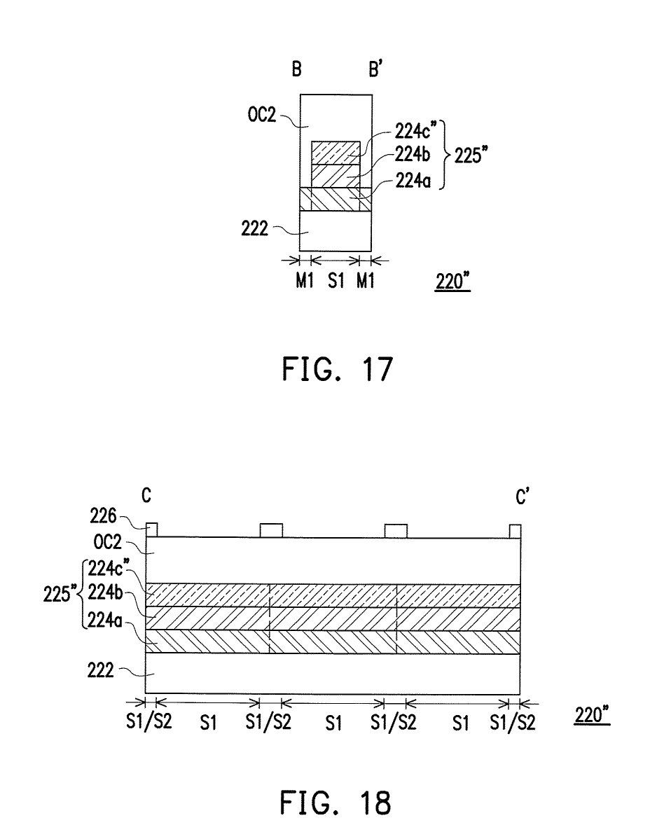

Besides, in the embodiment shown in FIG. 11 to FIG. 15, the stacked structures 225 of the color filter substrate 220 are constituted by two color filter pattern layers, which should however not be construed as a limitation to the invention. In another embodiment of the invention, the stacked structures may be constituted by three color filter pattern layers, such that the stacked structures can achieve better light-shielding effects. Detailed descriptions are provided hereinafter with reference to FIG. 17 and FIG. 18.

FIG. 17 and FIG. 18 are schematic cross-sectional views illustrating a color filter substrate of an LCD panel according to another embodiment of the invention. The top schematic view illustrating the color filter substrate 220″ depicted in FIG. 17 and FIG. 18 can be similar to that provided in FIG. 12, wherein the location of the sectional line B-B′ in FIG. 12 may serve as a reference of the cross-sectional location shown in FIG. 17, and the location of the sectional line C-C′ in FIG. 12 may serve as a reference of the cross-sectional location shown in FIG. 18. The embodiment depicted in FIG. 17 and FIG. 18 is similar to that depicted in FIG. 11 to FIG. 15; therefore, the identical or similar devices in these embodiments are represented by the identical or similar reference numbers and will not be further explained.

As shown in FIG. 14, FIG. 15, FIG. 17, and FIG. 18, the difference between the color filter substrate 220″ and the color filter substrate 220 lies in that the third color filter pattern layer 224c″ in the color filter substrate 220″ is further disposed in the first light-shielding regions S1 and is stacked onto the second and first color filter pattern layers 224b and 224a, so as to form a plurality of stacked structures 225″. In the color filter substrate 220, the third color filter pattern layer 224c is not disposed in the first light-shielding regions S1, and the stacked structures 225 are merely constituted by the second and first color filter pattern layer 224b and 224a.

It should be mentioned that the optical density of the stacked structures 225″ constituted by the third color filter pattern layer 224c″, the second color filter pattern layer 224b, and the first color filter pattern layer 224a is approximately 3-6; hence, the stacked structures 225″ are capable of achieving better light-shielding effects in comparison with the stacked structure 225. As such, compared with the stacked structures 225, the stacked structures 225″ located in the first light-shielding regions S1 can more effectively cover the components that are not supposed to be observed by users.

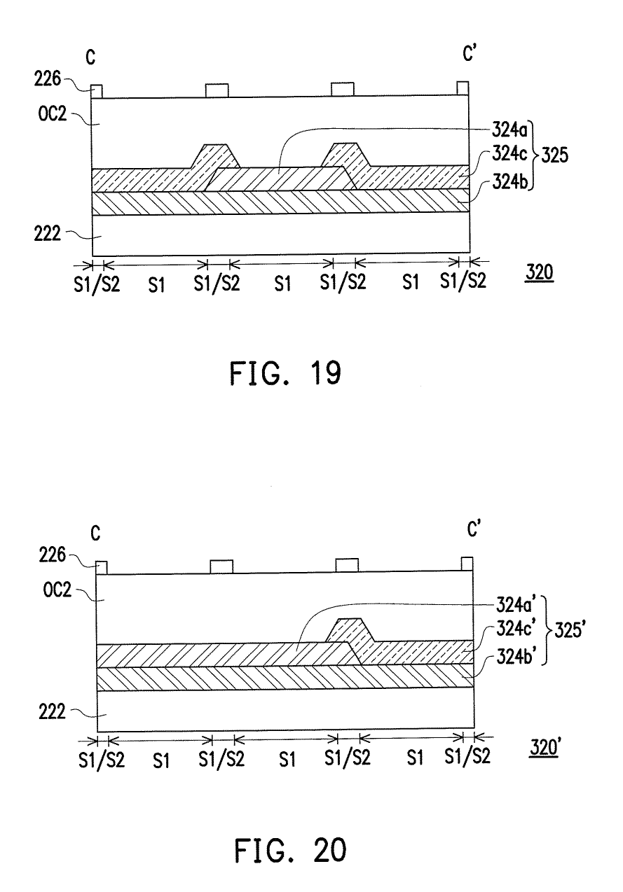

According to the embodiment provided in FIG. 11 to FIG. 15, the stacked structures 225 located in the first light-shielding regions S1 contains two layers constituted by stacking the second color filter pattern layer 224b onto the first color filter pattern layer 224a; and in the embodiment shown in FIG. 17 to FIG. 18, the stacked structures 225″ located in the first light-shielding regions S1 contains three layers constituted by sequentially stacking the first, second, and third color filter pattern layers 224a, 224b, and 224c″. Nevertheless, the invention is not limited thereto; as long as the stacked structures are constituted by sequentially stacking at least two of the first, second, and third color filter pattern layers, the stacked structures fall within the scope of protection provided herein. Several embodiments of the stacked structures will be elaborated below with reference to FIG. 19 to FIG. 20.

FIG. 19 is a schematic cross-sectional view illustrating a color filter substrate of an LCD panel according to another embodiment of the invention. The top schematic view illustrating the color filter substrate 320 depicted in FIG. 19 can be similar to that provided in FIG. 12, and the location of the sectional line C-C′ in FIG. 12 may serve as a reference of the cross-sectional location shown in FIG. 19. The embodiment depicted in FIG. 19 is similar to that depicted in FIG. 11 to FIG. 15; therefore, the identical or similar devices in these embodiments are represented by the identical or similar reference numbers and will not be further explained. The difference between the LCD panels will be elaborated hereinafter.

With reference to FIG. 19, in the color filter substrate 320, the first, second, and third color filter pattern layers 324a, 324b, and 324c are all correspondingly located in the first light-shielding regions S1, and two-layer stacked structures 325 are formed by stacking the first and third color filter pattern layers 324a and 324c onto the second color filter pattern layer 324b, respectively. Particularly, in the present embodiment, the first and third color filter pattern layers 324a and 324c are merely arranged in parts of the first light-shielding regions S1, and an area occupied by the third color filter pattern layer 324c is greater than an area occupied by the first color filter pattern layer 324a.

Colors of the first, second, and third color filter pattern layers 324a, 324b, and 324c are different and are selected from red, green, and blue, respectively. In particular, the colors of the first, second, and third color filter pattern layers 324a, 324b, and 324c in the present embodiment are green, red, and blue, respectively.

FIG. 20 is a schematic cross-sectional view illustrating a color filter substrate of an LCD panel according to another embodiment of the invention. The top schematic view illustrating the color filter substrate 320′ depicted in FIG. 20 can be similar to that provided in FIG. 12, and the location of the sectional line C-C′ in FIG. 12 may serve as a reference of the cross-sectional location shown in FIG. 20. The embodiment depicted in FIG. 20 is similar to that depicted in FIG. 11 to FIG. 15; therefore, the identical or similar devices in these embodiments are represented by the identical or similar reference numbers and will not be further explained. The difference between the LCD panels will be elaborated hereinafter.

With reference to FIG. 20, in the color filter substrate 320′, the first, second, and third color filter pattern layers 324a′, 324b′, and 324c′ are all correspondingly located in the first light-shielding regions S1, and two-layer stacked structures 325′ are formed by stacking the first and third color filter pattern layers 324a′ and 324c′ onto the second color filter pattern layer 324b′, respectively. Particularly, in the present embodiment, the first and third color filter pattern layers 324a′ and 324c′ are merely arranged in parts of the first light-shielding regions S1, and an area occupied by the third color filter pattern layer 324c′ is less than an area occupied by the first color filter pattern layer 324a′.

Colors of the first, second, and third color filter pattern layers 324a′, 324b′, and 324c′ are different and are selected from red, green, and blue, respectively. In particular, the colors of the first, second, and third color filter pattern layers 324a′, 324b′, and 324c′ in the present embodiment are green, red, and blue, respectively.

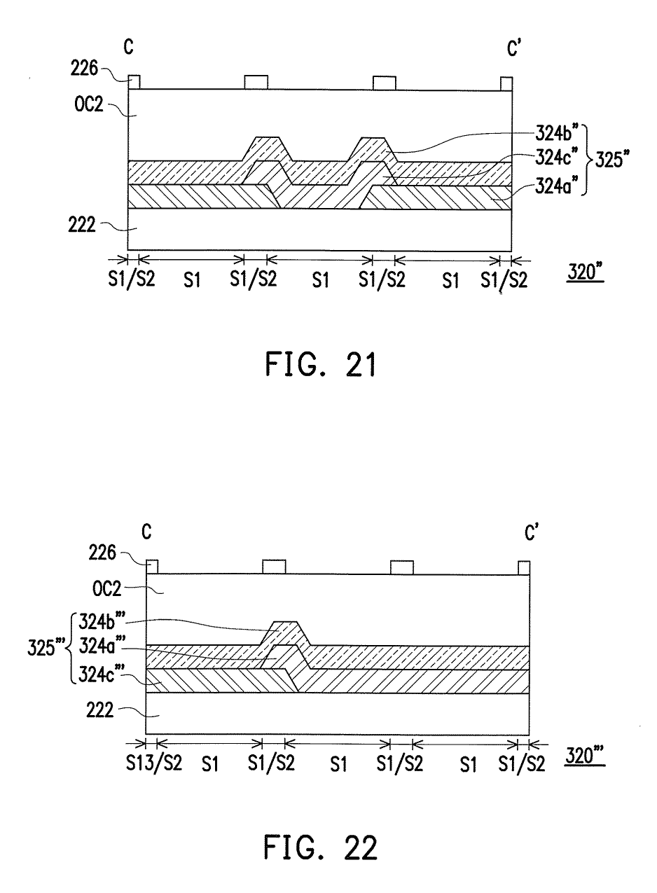

FIG. 21 is a schematic cross-sectional view illustrating a color filter substrate of an LCD panel according to another embodiment of the invention. The top schematic view illustrating the color filter substrate 320″ depicted in FIG. 21 can be similar to that provided in FIG. 12, and the location of the sectional line C-C′ in FIG. 12 may serve as a reference of the cross-sectional location shown in FIG. 21. The embodiment depicted in FIG. 21 is similar to that depicted in FIG. 11 to FIG. 15; therefore, the identical or similar devices in these embodiments are represented by the identical or similar reference numbers and will not be further explained. The difference between the LCD panels will be elaborated hereinafter.

With reference to FIG. 21, in the color filter substrate 320″, the first, second, and third color filter pattern layers 324a″, 324b″, and 324c″ are all correspondingly located in the first light-shielding regions S1, and stacked structures 325″ with at least two layers are formed by stacking the second color filter pattern layer 324b″ onto the first and third color filter pattern layers 324a″ and 324c″. Particularly, in the present embodiment, the first and third color filter pattern layers 324a″ and 324c″ are merely arranged in parts of the first light-shielding regions S1, and an area occupied by the third color filter pattern layer 324c″ is greater than an area occupied by the first color filter pattern layer 324a″.

Colors of the first, second, and third color filter pattern layers 324a″, 324b″, and 324c″ are different and are selected from red, green, and blue, respectively. In particular, the colors of the first, second, and third color filter pattern layers 324a″, 324b″, and 324c″ in the present embodiment are green, blue, and red, respectively.

FIG. 22 is a schematic cross-sectional view illustrating a color filter substrate of an LCD panel according to another embodiment of the invention. The top schematic view illustrating the color filter substrate 320′″ depicted in FIG. 22 can be similar to that provided in FIG. 12, and the location of the sectional line C-C′ in FIG. 12 may serve as a reference of the cross-sectional location shown in FIG. 22. The embodiment depicted in FIG. 22 is similar to that depicted in FIG. 11 to FIG. 15; therefore, the identical or similar devices in these embodiments are represented by the identical or similar reference numbers and will not be further explained. The difference between the LCD panels will be elaborated hereinafter.

With reference to FIG. 22, in the color filter substrate 320′″, the first, second, and third color filter pattern layers 324a′″, 324b′″, and 324c′″ are all correspondingly located in the first light-shielding regions S1, and stacked structures 325′″ with at least two layers are formed by stacking the second color filter pattern layer 324b′″ onto the first and third color filter pattern layers 324a′″ and 324c′″. Particularly, in the present embodiment, the first and third color filter pattern layers 324a′″ and 324e are merely arranged in parts of the first light-shielding regions S1, and an area occupied by the third color filter pattern layer 324c′″ is less than an area occupied by the first color filter pattern layer 324a′″.

Colors of the first, second, and third color filter pattern layers 324a′″, 324b′″, and 324c′″ are different and are selected from red, green, and blue, respectively. In particular, the colors of the first, second, and third color filter pattern layers 324a′″, 324b′″, and 324c′″ in the present embodiment are green, blue, and red, respectively.

Although the aforesaid color filter substrates (i.e., the color filter substrates 320, 320′, 320″, and 320′″) in which the stacked structures (i.e., the stacked structures 325, 325′, 325″, and 325′″) and the scan lines 114b are overlapped and the light-shielding pattern layer 226 and the data lines 114a are overlapped are applied to elaborate the other variations in the stacked structures, people having ordinary skill in the pertinent art should be able to understand other variations in the stacked structures while the stacked structures and the data lines 114a are overlapped and the light-shielding pattern layer and the scan lines 114b are overlapped according to the disclosure.

To sum up, the stacked structures constituted by the color filter pattern layers and the light-shielding layer which belong to different film layers are respectively arranged in the first and second light-shielding regions; thereby, the stacked layers and the light-shielding pattern layer can replace the conventional black matrix layer and effectively block the devices that are not supposed to be observed by the users, and both corner rounding in the LCD panel can be prevented, such that the aperture ratio can be raised. As a result, the LCD panel provided in the embodiments of the invention can have high resolution, and can still effectively block the devices from the users' sight and have satisfactory aperture ratio.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A liquid crystal display panel comprising:
a first substrate;
a plurality of first signal lines and a plurality of second signal lines disposed on the first substrate;
a plurality of pixel structures correspondingly electrically connected to the first signal lines and the second signal lines, each of the pixel structures comprising:
an active device electrically connected one of to the first signal lines and one of the second signal lines; and
a first electrode layer electrically connected to the active device;
a second substrate located opposite to the first substrate, the second substrate having a plurality of first light-shielding regions, a plurality of second light-shielding regions, a plurality of first light-transmissive regions, a plurality of second light-transmissive regions, and a plurality of third light-transmissive regions, wherein the first light-shielding regions and the second light-shielding regions define the first, second, and third light-transmissive regions;
a first color filter pattern layer correspondingly disposed in the first light-transmissive regions and the first light-shielding regions;
a second color filter pattern layer correspondingly disposed in the second light-transmissive regions and the first light-shielding regions, the first color filter pattern layer and the second color filter pattern layer being stacked together in the first light-shielding regions, the second color filter pattern layer being substantially completely overlapped with the first signal lines in the first light-shielding regions but not completely overlapped with the second signal lines;
a third color filter pattern layer correspondingly disposed in the third light-transmissive regions;
a light-shielding pattern layer correspondingly disposed in the second light-shielding regions and located to overlap with the first, second, and third color filter pattern layers, wherein the light-shielding pattern layer is substantially completely overlapped with the second signal lines in the second light-shielding regions but not completely overlapped with the first signal lines; and
a liquid crystal medium located between the first substrate and the second substrate.

2. The liquid crystal display panel of claim 1, wherein the third color filter pattern layer is further disposed in the first light-shielding regions.

3. The liquid crystal display panel of claim 1, further comprising a planarization layer disposed between the light-shielding pattern layer and the first, second, and third color filter pattern layers.

4. The liquid crystal display panel of claim 1, wherein each of the pixel structures further comprises a second electrode layer, and a potential difference exists between the first electrode layer and the second electrode layer.

5. The liquid crystal display panel of claim 1, wherein the first signal lines are scan lines, the second signal lines are data lines, and a width of the first light-shielding regions is greater than a width of the second light-shielding regions.

6. The liquid crystal display panel of claim 1, wherein the first signal lines are scan lines, the second signal lines are data lines, the light-shielding pattern layer is further correspondingly disposed in the first light-shielding regions, and a width of the light-shielding pattern layer in the first light-shielding regions is less than a width of the first light-shielding regions.

7. The liquid crystal display panel of claim 1, wherein the first signal lines are data lines, the second signal lines are scan lines, and a width of the first light-shielding regions is less than a width of the second light-shielding regions.

8. The liquid crystal display panel of claim 1, wherein a material of the light-shielding pattern layer comprises black resin or metal, colors of the first, second, and third color filter pattern layers are different and are selected from red, green, and blue, respectively.

9. A liquid crystal display panel comprising:
a first substrate;
a plurality of first signal lines and a plurality of second signal lines disposed on the first substrate;
a plurality of pixel structures correspondingly electrically connected to the first signal lines and the second signal lines,
a liquid crystal medium;
a second substrate located opposite to the first substrate, the liquid crystal medium being disposed between the first substrate and the second substrate; and
a first color filter pattern layer, a second color filter pattern layer, a third color filter pattern layer, and a light-shielding pattern layer all disposed between the second substrate and the liquid crystal medium, wherein at least two of the first, second, and third color filter pattern layers are stacked together merely above the first signal lines, and the first, second, and third color filter pattern layers are located between the light-shielding pattern layer and the second substrate.

10. The liquid crystal display panel of claim 9, wherein the pixel structures are arranged in an array and constitute a plurality of pixel columns, the first, second, and third color filter pattern layers are sequentially arranged on corresponding pixel columns of the pixel columns, and wherein colors of the first, second, and third color filter pattern layers are different and are selected from red, green, and blue, respectively.
